(19) United States
(12) Patent Application Publication
(10) Pub. No.: US 2019/0221812 A1
(43) Pub. Date: Jul. 18, 2019

(54) Method for Manufacturing Fast Charging and Long Life Li-S Batteries

(71) Applicant: Academia Sinica, Taipei (TW)

(72) Inventors: Chih-Wei CHU, Taipei City (TW); Nahid KAISAR, Taipei City (TW); Syed Ali ABBAS, Taipei City (TW)

(21) Appl. No.: 16/244,146

(22) Filed: Jan. 10, 2019

Related U.S. Application Data
(60) Provisional application No. 62/617,650, filed on Jan. 16, 2018.

(51) Int. Cl. H01M 2/16; H01M 2/14; H01M 10/052

(52) U.S. Cl. CPC H01M 2/1686; H01M 2/145; H01M 10/052; H01M 2/1646; H01M 2/1653

(57) ABSTRACT

The present invention provides a commercialized Li—S battery is applied in electronic appliance, such as hybrid electric vehicle (HEV), telecommunication, portable electronics, and device for renewable energy like solar and wind. The invention provides a method for manufacturing Li—S battery, comprising the following steps: firstly forming low dimensional materials on one side of a bilayer separator of a Li—S battery is achieved, and then forming a polymer on an other side of the bilayer separator of the Li—S battery to prevent a migration of polysulfide to anode side is completed.

### BACKGROUND OF THE INVENTION

### 1. Field of the Invention

The present invention provides a commercialized Li—S battery for electronic appliance, such as hybrid electric vehicle (HEV), telecommunication, portable electronics, and device for renewable energy like solar and wind.

### 2. Description of the Prior Art

The Worldwide thriving demand of rechargeable battery in daily use electronic devices is engrossing. Such accretive demand is partially fulfilled with conventional lead-acid, nickel-cadmium, nickel metal hydride and lithium-ion batteries but still insufficient.

Apart from being most electropositive metal, lithium (Li) is the lightest metal (M=6.94 g/mol, ρ=0.53 g/cm³) as well, motivating researchers to use it as an anode material in battery technology.

Battery technologies designed utilizing lithium metal was first introduced in 1991 to realize the mass production of portable rechargeable energy storage and further revolutionize the world electronic market. High theoretical capacity of 1672 mAh/g provided by elemental sulphur, featuring high abundancy, low-cost, as well as eco-friendliness, draws lots of interest from the researchers to use sulphur as a cathode material.

Despite these advantages, in reality, shuttling effect, insulating nature of sulphur (5×10⁻³⁰ S cm⁻¹ at room temperature) and large volume change of the active material during cycling would result in low gravimetric energy density and short cycle life, which impede the development of Li—S battery in industry.

The formation of polysulfides (Li₂Sₙ) on the cathode side during the electrochemical reaction arising from the presence of active material in the cathode leads to an undesirable phenomenon known as “shuttling effect”, which becomes one of the premier challenges to the researcher around the world. As well know, the shuttling effect will reduce the usage of the active material, and reduce the life cycle of the battery, and hence overcoming the shuttling effect becomes one of the main challenge for the worldwide researchers. Some research groups have tried to mitigate this problem by modifying conventional polypropylene (PP) separator.

### SUMMARY OF THE INVENTION

The invention enables ultra-fast charge-discharge rate in Li—S (Lithium-Sulfur) batteries and makes it possible to commercialize Li—S batteries as next generation batteries.

The invention provides the method for manufacturing a bilayer separator of a Li—S battery, comprising the following steps: the plurality of MoO₃ particles are mixed in the isopropyl alcohol, the plurality of MoO₃ particles are grinded to form as the plurality of MoO₃ nanorods, MoO₃ nanorods are dispersed in isopropyl alcohol and coated onto the PP separator in order to form as the MoO₃ coated nanorods PP separator, the MoO₃ coated nanorods PP separator are dries and the bilayer separator is assembled into Li—S batteries.

The invention provides a bilayer separator for Li—S batteries, comprising MoO₃ (as the low-dimensional materials) forming on one side of bilayer separator of Li—S batteries and polymers on the other side of the bilayer separator of Li—S batteries to prevent the migration of polysulfides.

Li—S batteries using the invention will perform outstanding stability even at high C-rate (1 C=1672 mAh/g).

Battery performance at 5 C shows that it is possible to charge Li—S battery within 10 minutes, which is less than the time to be needed to refill the fuel tank of the vehicles.

Increasing demand of electronic devices with high energy density is the key motivation to develop Li—S battery as the next generation battery technology.

Herein, a bilayer separator includes:

One side coated with molybdenum trioxide (MoO₃) nanorods while the other side is polypropylene (pp) separator.

Commercial MoO₃ bulk particle is dispersed in IPA solution and grinded using a home-made grinding machine to produce MoO₃ nanorods.

At 5 C, Li—S batteries with MoO₃ coated separator showed excellent performance up to 5000 cycles with a decay rate of 0.014% per cycle.

With this invention, 29.4% of the initial discharge capacity of Li—S batteries was retained after 5000 cycle at 5 C while columbic efficiency maintained above 80%, showing a. high mobility of Li⁺ ions within the electrodes.

With this invention providing the modified bilayer separator, Li—S batteries has a good potential to he commercialized.

### BRIEF DESCRIPTION OF THE DRAWINGS

The foregoing aspects and many of the attendant advantages of this invention will become more readily appreciated and understood by referring to the following detailed description, and taken in conjunction with the accompanying figures, wherein:

FIG. 1 illustrates the structure of a Lithium-Sulfur battery;

FIG. 2 illustrates the procedure of manufacturing bilayer separator for Li—S batteries;

FIG. 3 Schematic representation of Lithium-Sulfur batteries using MoO₃ coated PP separator and illustration of the working process;

FIG. 4 SEM images of as prepared nano-membranes, nano-belts, and nanoparticles of graphite, MoO₃ and NbSe₂ respectively;

FIG. 5A SEM images of commercial bulk MoO₃;

FIG. 5B SEM images of MoO₃ nanorods after grinding;

FIG. 6 Cycling performance of Lithium-Sulfur battery with MoO₃ coated PP separator at 5 C rate;

FIG. 7 Discharge capacities of Lithium-Sulfur batteries with MoO₃ coated separator at different C-rates;

Table 1 Comparison of Li—S battery performance using MoO₃ coated separator at different C rate.

### DESCRIPTION OF THE PREFERRED EMBODIMENT

In the following description, the attached Figures will be used to describe the implementation of the present invention. In the Figures, the same symbol of element is used to represent the same element. In order to explain clearly, the size or thickness of the element may be exaggerated.

To obtain the high energy density and long cycle life of Li—S battery, it is compulsory to obstruct the migration of polysulfides to the anode side by pushing them to the cathode side.

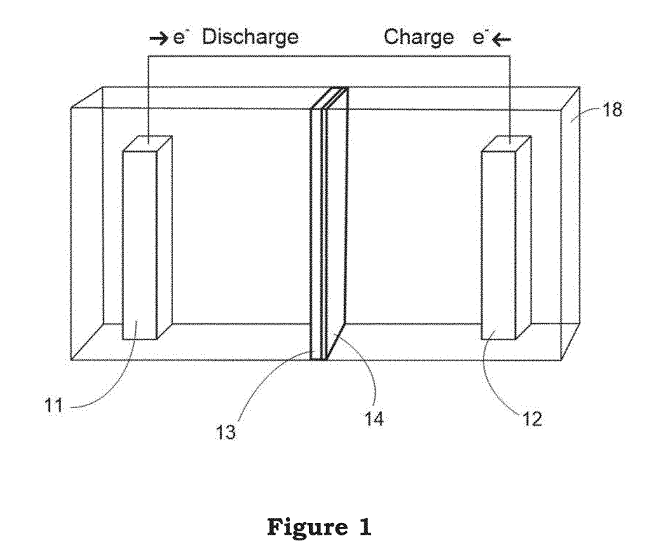

In FIG. 1, the invention provides a structure of a Li—S sulfur) battery, comprising anode 11, cathode 12, a polypropylene (PP) polymer separator 13 on one side of the bilayer isolation film of the Li—S battery, and a molybdenum oxide coated (MoO₃ coated) nanorods (PP separator) 14 on the other side of the bilayer isolation film of the Li—S battery. The structure of a Li—S battery comprises anode 11, cathode 12, and a bilayer isolation film (of the Li—S battery), wherein, the bilayer isolation film of Li—S battery comprises a polypropylene (PP) polymer separator 13, and the molybdenum oxide coated (MoO₃ coated) nanorods (PP separator) 14. The aforementioned anode 11, cathode 12, a polypropylene (PP) polymer separator 13, and MoO₃ coated nanorods PP separator 14 all are immersed in electrolyte 18 to prevent the migration of polysulfides.

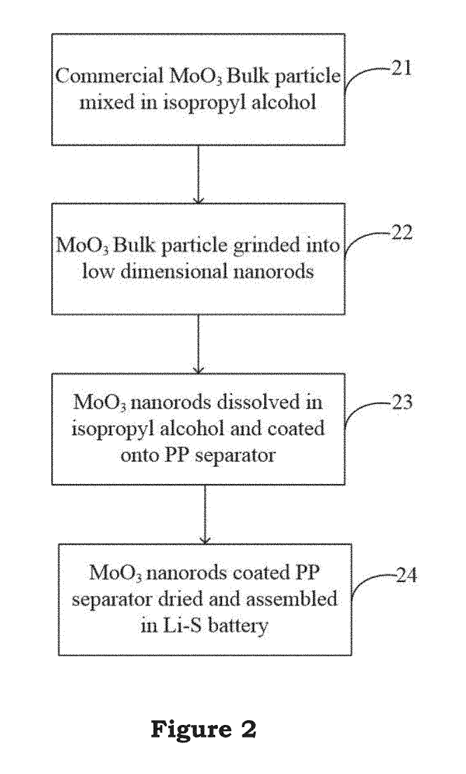

FIG. 2 shows the method for manufacturing a bilayer separator of a Li—S battery in the invention. In the step 21 of FIG. 2, firstly, the plurality of commercial MoO₃ (molybdenum trioxide) bulk particles are mixed (and dissolved) in the isopropyl alcohol.

Following and referring to the step 22 of FIG. 2, the plurality of commercial MoO₃ bulk particles are grinded in a home-made wet-grinding machine, to form as the MoO₃ (molybdenum trioxide) nanorods (into as low dimensional nanorods), further comprising such as the nano-membrane type, the nano-belt type and the nanoparticle type, that is, MoO₃ nano-membranes, MoO₃ nano-belts and MoO₃ nanoparticles.

Still as the step 22 of FIG. 2, wherein the plurality of MoO₃ (molybdenum trioxide) nanorods further comprises the plurality of nano-membranes composed of by mixing the graphite, niobium diselenide (NbSe₂) and molybdenum trioxide (MoO₃), the plurality of nano-belts composed of by mixing the graphite, niobium diselenide (NbSe₂) and molybdenum trioxide (MoO₃), and the plurality of nano-nanoparticles composed of by mixing the graphite, niobium diselenide (NbSe₂) and molybdenum trioxide (MoO₃).

Following and referring to step 23 of FIG. 2, a plurality of MoO₃ nanorods are dispersed in isopropyl alcohol and coated onto the PP separator in order to form as the molybdenum oxide coated (MoO₃ coated) nanorods PP separator 14.

Finally, referring to step 24 of FIG. 2, the above-mentioned MoO₃ coated nanorods PP separator 14 are dries and the bilayer separator is assembled into Li—S batteries.

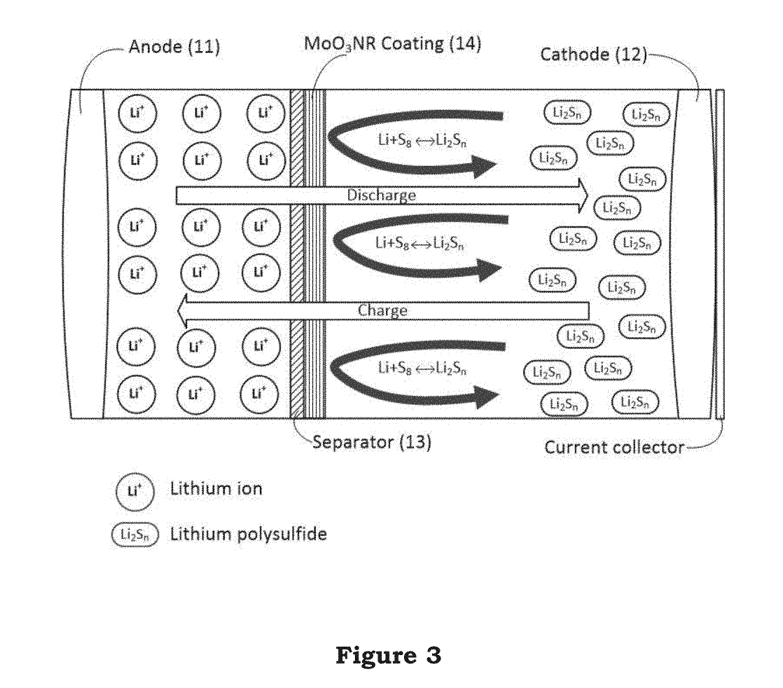

Please refer to the description in FIG. 3. FIG. 3 shows the Li—S battery by using the MoO₃-coated polypropylene (PP) separator and a schematic of the operating procedures. The invention provides a bilayer separator for Li—S batteries, comprising a low dimensional metal oxide (MoO₃) coated nanorods PP separator 14 forming on one side, and PP separator 13 on the other side of the bilayer separator in order to prevent the migration of polysulfides to the anode side.

Still in FIG. 3, one of the specific and feasible methods to mitigate the shuttle effect can be achieved by creating an obstacle that lays between the cathode and the separator so that polysulfides does not migrate through the separator.

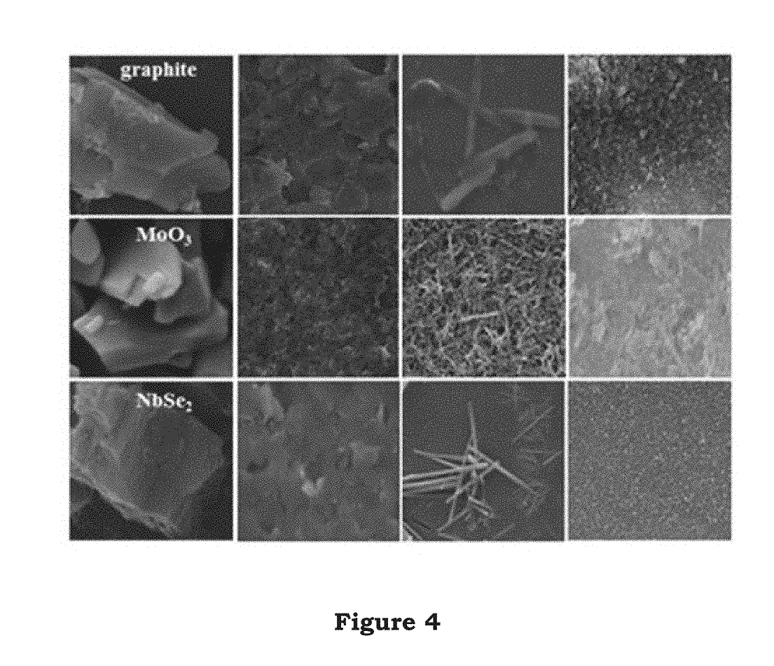

In FIG. 4, the scanning electron microscope (SEM) images of the nano-membranes, nano-belts, and nanoparticles of graphite, niobium diselenide (NbSe₂) and Molybdenum trioxide (MoO₃) respectively are shown.

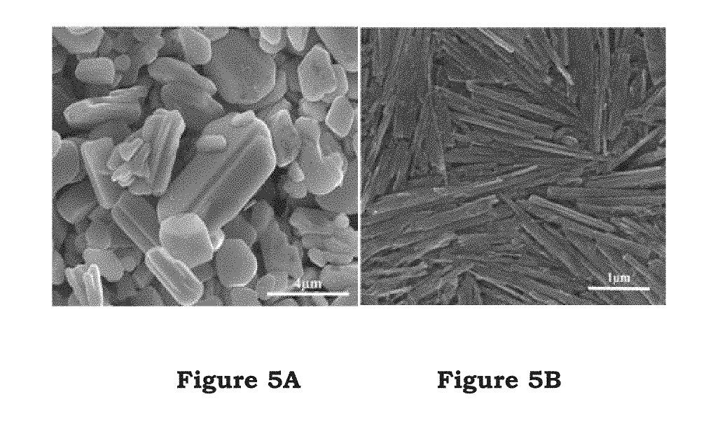

In FIG. 5A SEM images of commercial bulk MoO₃, illustrates that the low dimensional transition metal oxides prepared by the simple physical grinding process.

FIG. 5B exhibits the SEM images of MoO₃ NRs after grinding, illustrating that the as prepared MoO₃ NRs are collected and coated onto one side of PP separator.

Upon applying the external current, the cell starts to discharge and nucleophilic electrolyte with soluble polysulfides (Li₂Sₙ; 3≤n≤8) start to dissolve. Later on, higher-order polysulfides reduce to lower-order polysulfides (Li₂Sₙ; n=2−1) and move towards the anode side, resulting in low coulombic efficiency and low discharge capacity.

The presence of MoO₃ NRs on the separator confined the majority of the polysulfides to the cathode side, resulting in longer cycle life of the battery. The coulombic efficiency remains over 80% throughout 5000 cycles, revealing the easy-going movement of Li⁺ ion through the separator while preventing movement of polysulfides.

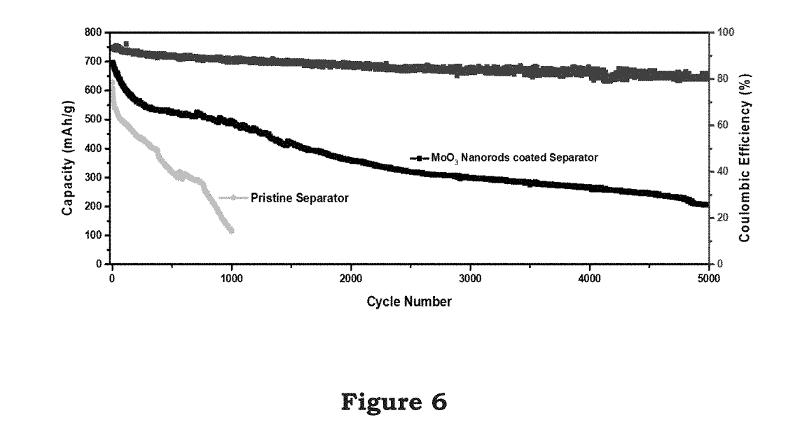

FIG. 6 illustrates that an initial capacity of 696 mAh/g was achieved at 5 C and at the end of 5000 cycle 29.4% initial discharge capacity retained with degradation rate of 0.014% per cycle.

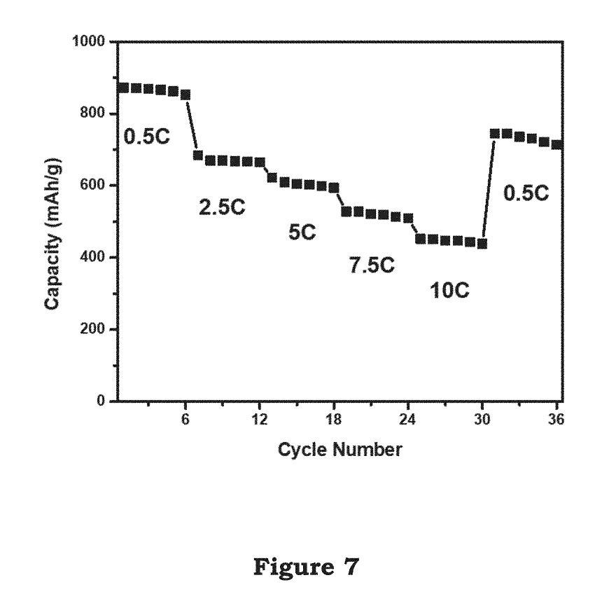

In FIG. 7, Rate capability of the Li—S battery using MoO₃ coated separator measured starting with 0.5 C rate followed by 2.5 C, 5 C, 7.5 C, 10 C and finally, return to 0.5 C and the test illustrates that the Li—S battery possesses very good rate capability by showing 85.6% retention of initial discharge capacity.

Again, in FIG. 6, the invention obtains very stable and long cycle performance of Li—S battery at 5 C. This proves that MoO₃ coated separator mitigate shuttling effect.

Table 1 summarizes the performance of the Li—S batteries using MoO₃ coated separator at different C-rate. The invention enables ultra-fast charge-discharge rate in Li—S batteries and makes them possible to be commercialized as next generation batteries.

In the invention, the battery performance under 5 C shows that the Li—S battery can be charged fully in less than 10 minutes, and even in fact, the time is shorter than to full up the fuel tank of the car.

TABLE 1

| | | | Capacity |
|---|---|---|---|
| | | Decay rate | retention |
| C - Rate* | Cycles/Day^{†} | (%) | (%) |
| 0.5 C^{‡} | 7.33 | 0.0355 | 82.25 |
| 1 C^{€} | 32.91 | 0.026 | 74 |
| 2 C^{€} | 52.04 | 0.018 | 72 |
| 3 C^{€} | 102.14 | 0.033 | 67 |
| 4 C^{€} | 128.5 | 0.038 | 62 |
| 5 C^{Ω} | 183.36 | 0.014 | 29.6 |

*1 C = 1672 mAh/g
^{†}One complete Charge-Discharge Cycle
^{‡}For 500 Cycles
^{€}For 1000 cycles
^{Ω}For 5000 cycles

The method for manufacturing a bilayer separator of a Li—S battery, the plurality of MoO₃ particles are mixed in the isopropyl alcohol, the a plurality of MoO₃ particles are grinded in a home-made wet-grinding machine, to form as the plurality of MoO₃ nanorods, the plurality of MoO₃ nanorods are dispersed in isopropyl alcohol and coated onto the PP separator in order to form as the MoO₃ coated nanorods PP separator, the MoO₃ coated nanorods PP separator are dries and the bilayer separator is assembled into Li—S batteries.

In the above summary, using the commercialized Li—S battery of the invention can be applied in electronic appliance, such as hybrid electric vehicle (HEV), telecommunication, portable electronics, and device for renewable energy like solar and wind.

It is understood that various other modifications will be apparent to and can be readily made by those skilled in the art without departing from the scope and spirit of this invention. Accordingly, it is not intended that the scope of the claims appended here to be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A bilayer isolation film of a Li—S battery, comprising:
a polymer separator on one side of a bilayer isolation film of said Li—S battery; and a metal oxide coated nanorods PP separator formed on another side of said bilayer isolation film of a Li—S battery.

2. The bilayer isolation film of a Li—S battery according to claim 1, wherein said metal oxide coated nanorods PP separator comprises a MoO₃ coated nanorods PP separator.

3. The bilayer isolation film of a Li—S battery according to claim 2, wherein said plurality of MoO₃ nanorods is selected from the group consisting of a plurality of nano-membranes composed of by mixing the graphite, NbSe₂ and MoO₃, a plurality of nano-belts composed of by mixing the graphite, NbSe₂ and MoO₃, and the plurality of nano-nanoparticles composed of by mixing the graphite, NbSe₂ and MoO₃.

4. The bilayer isolation film of a Li—S battery according to claim 1, wherein said polymer separator comprises a polypropylene (PP) separator.

5. A method for manufacturing a bilayer separator of a Li—S battery, comprising:
mixing a plurality of MoO₃ particles in an isopropyl alcohol, grinding said plurality of MoO₃ particles in a home-made wet-grinding machine in order to form as a MoO₃ nanorods, dispersing said plurality of MoO₃ nanorods in an isopropyl alcohol and coating said plurality of MoO₃ nanorods onto a PP separator in order to form as a MoO₃ coated nanorods PP separator, and drying said MoO₃ coated nanorods PP separator and said bilayer separator is assembled into Li—S batteries.

6. The bilayer isolation film of a Li—S battery according to claim 5, wherein said metal oxide coated nanorods PP separator comprises a MoO₃ coated nanorods PP separator.

7. The bilayer isolation film of a Li—S battery according to claim 6, wherein said plurality of MoO₃ nanorods is selected from the group consisting of a plurality of nano-membranes composed of by mixing the graphite, NbSe₂ and MoO₃, a plurality of nano-belts composed of by mixing the graphite, NbSe₂ and MoO₃, and the plurality of nano-nanoparticles composed of by mixing the graphite, NbSe₂ and MoO₃.

8. The bilayer isolation film of a Li—S battery according to claim 5, wherein said polymer separator comprises a polypropylene (PP) separator.

9. The structure of a Li—S battery comprises:
an anode, a cathode, and a bilayer isolation film.

10. The structure according to claim 9, wherein said bilayer isolation film, comprises:
a polymer separator on one side of a bilayer isolation film of said Li—S battery, and a metal oxide coated nanorods PP separator formed on another side of said bilayer isolation film of a Li—S battery.

11. A bilayer isolation film of a Li—S battery, comprising:
a polymer separator on one side of a bilayer isolation film of said Li—S battery; and
a metal oxide coated nanorods PP separator formed on another side of said bilayer isolation film of a Li—S battery.

12. The bilayer isolation film of a Li—S battery according to claim 11, wherein said metal oxide coated nanorods PP separator comprises a MoO₃ coated nanorods PP separator.

13. The bilayer isolation film of a Li—S battery according to claim 12, wherein said plurality of MoO₃ nanorods is selected from the group consisting of a plurality of nano-membranes composed of by mixing the graphite, NbSe₂ and MoO₃, a plurality of nano-belts composed of by mixing the graphite, NbSe₂ and MoO₃, and the plurality of nano-nanoparticles composed of by mixing the graphite, NbSe₂ and MoO₃.

14. The bilayer isolation film of a Li—S battery according to claim 11, wherein said polymer separator comprises a polypropylene (PP) separator.

15. A method for manufacturing a bilayer separator of a Li—S battery, comprising:
mixing a plurality of MoO₃ particles in an isopropyl alcohol;
grinding said plurality of MoO₃ particles in a home-made wet-grinding machine in order to form as a MoO₃ nanorods;
dispersing said plurality of MoO₃ nanorods in an isopropyl alcohol and coating said plurality of MoO₃ nanorods onto a PP separator in order to form as a MoO₃ coated nanorods PP separator; and
drying said MoO₃ coated nanorods PP separator and said bilayer separator is assembled into Li—S batteries.

16. The bilayer isolation film of a Li—S battery according to claim 1 wherein said metal oxide coated nanorods PP separator comprises a MoO₃ coated nanorods PP separator.

17. The bilayer isolation film of a Li—S battery according to claim 16, wherein said plurality of MoO₃ nanorods is selected from the group consisting of a plurality of nano-membranes composed of by mixing the graphite, NbSe₂ and MoO₃, a plurality of nano-belts composed of by mixing the graphite, NbSe₂ and MoO₃, and the plurality of nano-nanoparticles composed of by mixing the graphite, NbSe₂ and MoO₃.

18. The bilayer isolation film of a Li—S battery according to claim 15, wherein said polymer separator comprises a polypropylene (PP) separator.

19. The structure of a Li—S battery comprises:
an anode;
a cathode; and
a bilayer isolation film.

20. The structure according to claim 19, wherein said bilayer isolation film, comprises:
a polymer separator on one side of a bilayer isolation film of said Li—S battery; and
a metal oxide coated nanorods PP separator formed on another side of said bilayer isolation film of a Li—S battery.
